(19) United States
(12) Patent Application Publication
(10) Pub. No.: US 2012/0191607 A1
(43) Pub. Date: Jul. 26, 2012

(54) Methods And Systems For Facilitating Or Executing Electronic Payment Transactions

(75) Inventors: Clint Walter Lord, Sandy, UT (US); Wayne William Peck, Sandy, UT (US); Christopher Andrew Mark, Park City, UT (US); Heather Lee Mark, Park City, UT (US)

(73) Assignee: ProPay, Inc., Lehi, UT (US)

(21) Appl. No.: 13/011,309

(22) Filed: Jan. 21, 2011

(51) Int. Cl. G06Q 20/40

(52) U.S. Cl. 705/44

(57) ABSTRACT

A method for executing an electronic payment transaction may include initiating or receiving notification of the initiating of a communication session with a wireless data connection enabled computing device, sending a payment transaction request during the communication session for the wireless data connection enabled computing device, and receiving a payment confirmation or a rejection of the payment transaction request to conclude the payment transaction.

### BACKGROUND

The increased flow of information between merchants and customers may be beneficial to both parties. Customers may be able to more quickly decide whether a particular merchant can satisfy their needs. Merchants may be able to more effectively reach out to their customer base.

### SUMMARY

A method to facilitate an electronic payment transaction may include receiving a request to initiate a communication session between a merchant terminal and a wireless data connection enabled computing device, sending identifying information for the communication session to at least one of the merchant terminal and the wireless data connection enabled computing device, and receiving a payment transaction request from the merchant terminal during the communication session. The method may further include sending the payment transaction request to the wireless data connection enabled computing device during the communication session, receiving a purchase authorization for the payment transaction request from the wireless data connection enabled computing device, and sending the payment transaction to a payment processor. The method may still further include receiving an approval of the payment transaction from the payment processor and sending notification of the approval of the payment transaction to at least one of the merchant terminal and the wireless data connection enabled computing device to conclude the payment transaction.

A method to execute an electronic payment transaction may include initiating or receiving notification of the initiating of a communication session with a merchant terminal, receiving a payment transaction request during the communication session from the merchant terminal, sending an authorization for the payment transaction request, and receiving an approval of the payment transaction to conclude the payment transaction.

A method for executing an electronic payment transaction may include initiating or receiving notification of the initiating of a communication session with a wireless data connection enabled computing device, sending a payment transaction request during the communication session for the wireless data connection enabled computing device, and receiving a payment confirmation or a rejection of the payment transaction request to conclude the payment transaction.

### BRIEF DESCRIPTION OF THE DRAWINGS

FIGS. 1 through 4 are process flow diagrams illustrating the electronic exchange of information between a wireless data connection enabled computing device and merchant terminal facilitated by a payment management system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The widespread adoption of mobile computing devices capable of wireless communication (e.g., cell phones, lap top computers, etc.) has created new opportunities for information exchange between merchants (including non merchant organizations such as churches, charities, etc.) and customers (including potential customers, users, etc.) Merchant information (such as products available, sale items, etc.) previously conveyed via signage, for example, may now be transmitted for receipt by a customer's mobile device (such as a cell phone). Issues, however, may hinder this information exchange. A merchant, for example, may encounter difficulty in determining who and/or when to send their information. Likewise, a customer may not know which of several merchants are capable of such wireless information exchange.

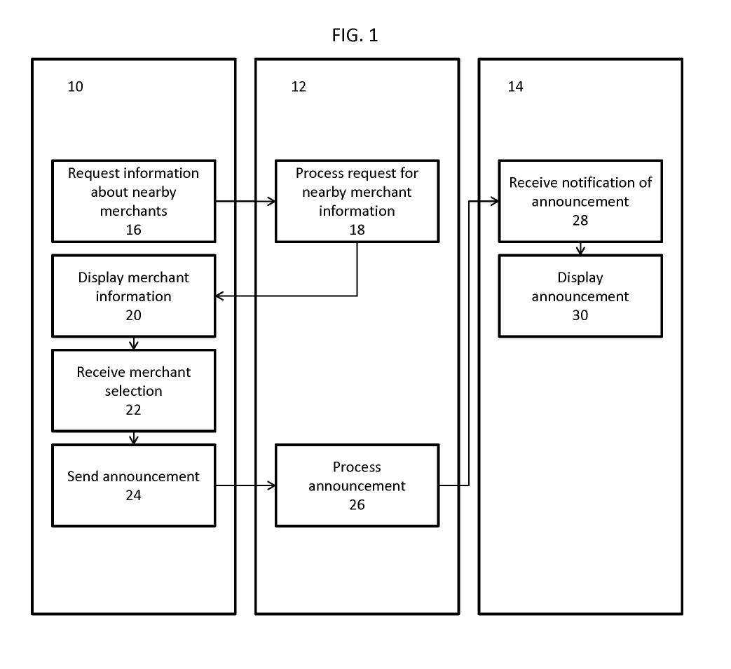

Referring to FIG. 1, an example process flow to initiate communications between a merchant and customer/potential customer/user is illustrated. A customer may download or otherwise obtain a copy of client terminal software or a mobile application that executes on a mobile client 10 (such as a cell phone, lap top computer, electronic tablet or other client) that can communicate with a secure data store and payment management system 12 (which may include web and database servers) using, for example, a wireless enabled data connection (e.g., Wi-Fi, cellular, etc.) When the customer executes the mobile application for the first time, he may go through a signup process to create a user account. The customer enters information such as name, user credentials (which may include a username, password and PIN), email address and other identifying information. The mobile application may then send the user entered information along with other identifying information (such as mobile device identification) to the payment management system 12 which creates a user account with the given information. The payment management system 12 may send a confirmation of successful account creation (or, if not successful, an error response) to the mobile client 10.

The customer may view nearby merchants 14 by navigating to the nearby merchant functionality on the mobile application. At operation 16, a request is sent to the payment management system 12 which, in this example, uses geo-location information or similar technology provided by the mobile client 10 to find merchant accounts that are nearby (based on a configured distance). The requested information is sent back to the mobile client 10 at operation 18. At operation 20, the nearby merchant information is displayed on the mobile client 10. The customer may also use other filters to find merchants such as last used (previous merchants that have been communicated with), most used, or search functionality which would allow the user to find a merchant based on identifying information such as name or address.

At operation 22, the customer may choose which merchant he wants to communicate with from the displayed merchant list. At operation 24, the software then initiates a communication session by sending announcement information to the payment management system 12, which processes that information and sends the announcement to the merchant terminal 14 at operation 26.

The merchant terminal 14 may be any interface that allows a merchant to view and/or manage the communication between the merchant and the customer including but not limited to a web browser, a mobile application running on a mobile platform, or an application running on a desktop computer. The merchant terminal 14 may also be an existing point of sale application that is integrated with the payment management system 12.

The merchant terminal 14 receives the announcement at operation 28 and displays the announcement at operation 30. This provides the merchant the visibility needed to communicate with the customer. Because of the disconnected nature of the system (the payment management system 12 being the facilitator between the mobile client 10 and the merchant terminal 14), the customer and the merchant may participate in two-way (full duplex) communication allowing either party to send messages and act on them asynchronously. Other communication schemes (half duplex, synchronous, etc.), however, are also contemplated.

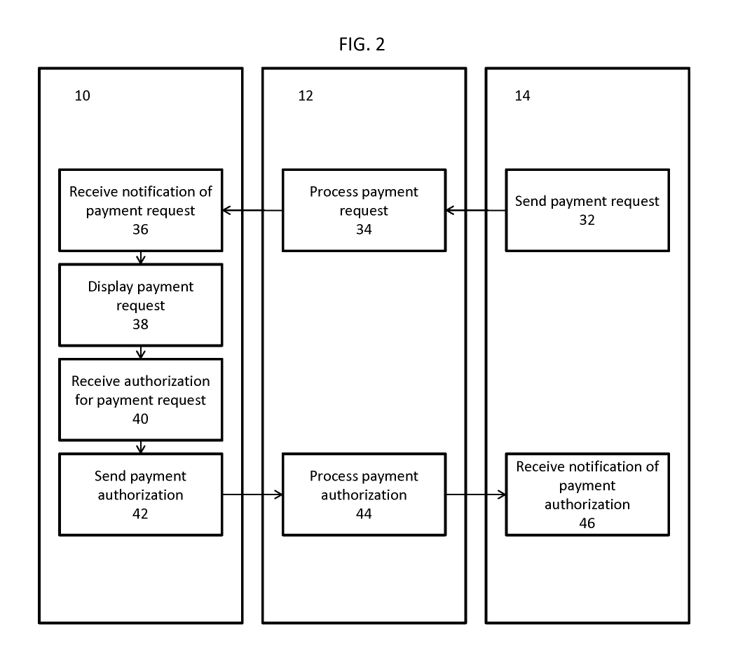

Referring to FIG. 2, an example of one type of communication between the merchant and customer (a payment transaction) is illustrated. The payment request may be initiated by a merchant at the merchant terminal 14. The payment request may contain information about the payment including amount, merchant name and invoice details (such as items, services, taxes, etc.) A payment request is sent to the payment management system 12 at operation 32. At operation 34, the payment management system 12 then processes and sends the request to the customer's mobile client 10 selected from the merchant terminal 14 by the merchant.

Similar to the scenario described above, a customer may initiate the payment request by submitting his customer identifier, such as username, to a merchant's system (such as a website or an IVR) that is integrated with the payment management system 12. This may be illustrated with reference to FIG. 2 by replacing the merchant terminal 14 with an integrated merchant system. The merchant system may programmatically initiate a communication session with a mobile application (if one has not already been initiated) and send a payment request to the payment management system 12 for the identified customer at operation 32. The payment management system 12 then processes the request as before at operation 34. An example would be an e-commerce transaction in which the merchant's system is a website, and the customer would be asked to enter his user identifier in a textbox. Another example would be a call center in which the customer, instead of entering the identifier himself, would communicate the customer identifier over the phone to a customer service representative who would then enter the identifier into the merchant's system (in this case, client software at the call center) that has been integrated with the payment management system 12.

The mobile client 10 receives the payment request at operation 36 and may notify the customer through an alert (e.g., a pop up, dialogue box, etc.), and displays the request at operation 38 for the customer to respond to. The customer may either reject the payment request or initiate a payment. To initiate a payment, the customer may first select a payment method with which to pay. Payment methods may be added once the customer has successfully created an account. To add a payment method, the customer may enter financial account information for each payment method. The software may send the information to the payment management system 12 over an encrypted connection which securely encrypts and stores the payment method and associates it with the user account. Payment methods may include financial accounts such as credit card accounts, debit card accounts, bank accounts (for EFT) and other accounts.

The customer may optionally enter additional transaction information (which may be configured by the merchant) such as a tip. The customer may authorize the transaction by entering authorization information such as a signature or PIN, etc. The customer may enter a PIN and/or other authentication information before the payment approval (which may also contain system/customer identification information such as geo-location information, time and date information, device identification, etc.) is received at operation 40 and sent to the payment management system 12 at operation 42.

At operation 44, the payment management system 12 receives the payment approval and starts the payment process. The payment management system 12 may authenticate the user credentials and the merchant information included in the payment approval, verify and store the authorization information included in the payment approval, store customer/system identification information included in the payment approval, and decrypt and send the payment method information identified by the payment approval and securely stored by the payment management system 12 to a payment processor (e.g., payment processor, payment gateway, direct connect merchant, ACH originator, etc.) to initiate the financial transaction with the underlying banking network. When the transaction response is returned from the network, it may be sent to the merchant terminal 14 at operation 46 and/or the mobile client 10 indicating either a decline or approval. If the transaction response is a decline, the customer may select another payment method and try again.

All payment request information including amounts, invoice information, response codes, etc. may be stored as a historical record on the mobile client 10 and/or the payment management system 12 and/or the merchant terminal 14. The payment transaction history information may be made available to the customer or merchant to be viewed, printed, exported, etc.

The customer, instead of approving the payment request at operation 42, may optionally reject the payment request. The client application may then send the rejection notification to the payment management system 12, which then notifies the merchant terminal 14. The merchant terminal 14 may then display the pending request as a cancelled request.

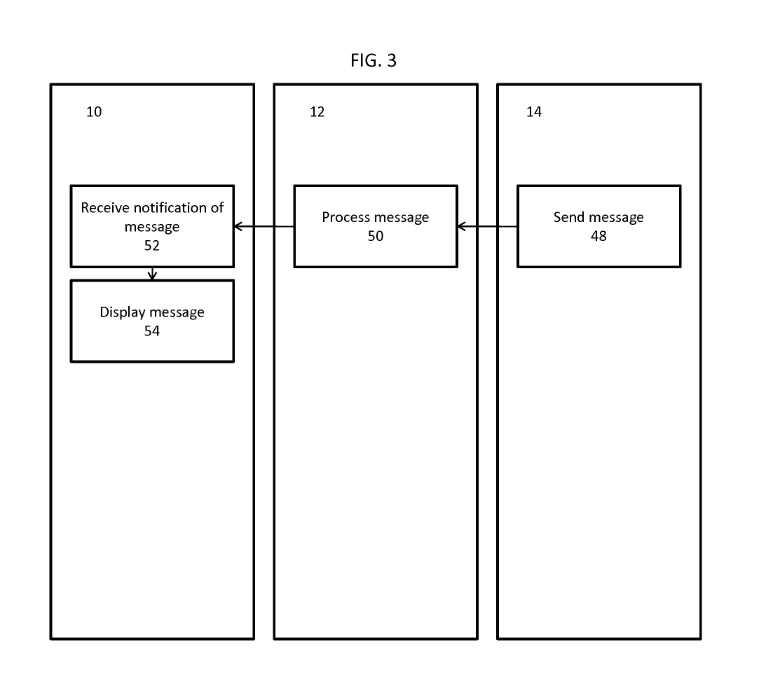

Referring to FIG. 3, an example of another type of communication between the merchant and customer is illustrated. This type of communication may include event information. An event may be one of a number of event types (such as chat messages, coupons, show times, concerts, sporting events, menus, discounts, advertisements, greetings, ticketing information, etc.) and may be sent in the form of text, graphics, video, etc. As with the payment transaction example, the communication may be initiated through the merchant terminal 14 or programmatically through an integrated merchant system.

At operation 48, a message event is sent to the payment management system 12. The payment management system 12 processes and sends the message event to the mobile client 10 at operation 50. The mobile client 10 receives the message event at operation 52 and can notify the customer through an alert (e.g., a pop up, etc.), and displays the message event at operation 54 for the customer to view and potentially respond to.

Events may be sent programmatically in response to a request from the mobile application. The mobile application may request all (or selected) event types from the merchants displayed on the merchant list. For example, the customer may want to view all nearby merchants with coupons, or the customer may want to view all discounts from his favorite merchants. The requested event types may be sent to the payment management system 12 at operation 48 and continue through the scenario as illustrated in FIG. 3.

Events may also be sent programmatically in response to the initiation of the communication session. When a customer announces himself to a merchant for example, a default message event may be sent automatically to the customer welcoming the customer to the establishment.

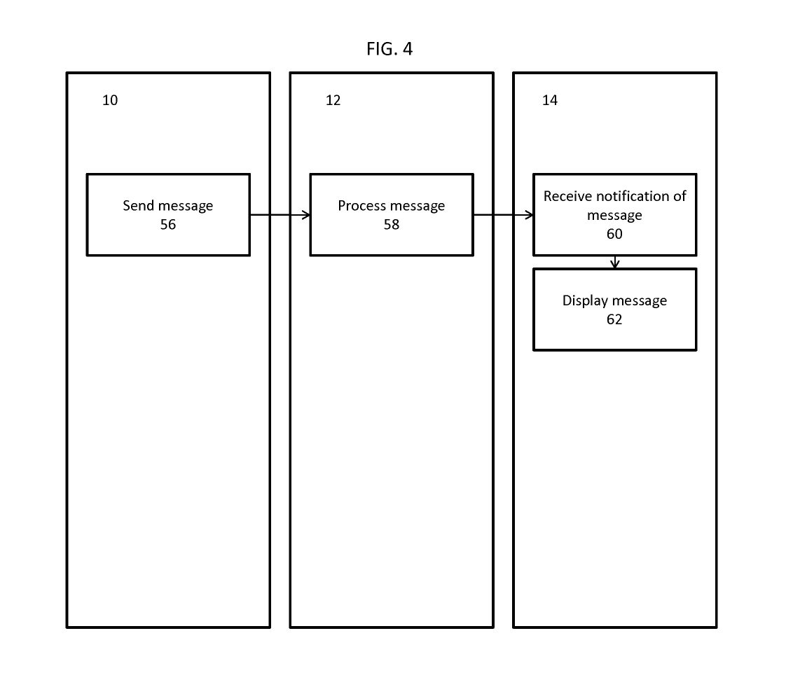

Referring to FIG. 4, an example of the customer initiating a message event to the merchant is illustrated. The customer enters a message through the mobile application, which then sends the message event at operation 56 to the payment management system 12. The payment management system 12 processes the message event at operation 58 and sends it to the merchant console 14. The merchant console 14 then receives the message event at operation 60 and displays it at operation 62 for the merchant to view and potentially respond to. In some cases, multiple merchant consoles may receive the same message event (the message event is sent to all of a merchant's terminals in one store).

The algorithms disclosed herein may be deliverable to/implemented by one or more processing devices, such as the client 10, payment management system 12 and merchant terminal 14, which may include any existing electronic control unit or dedicated electronic control unit, in many forms including, but not limited to, information permanently stored on non-writable storage media such as ROM devices and information alterably stored on writeable storage media such as floppy disks, magnetic tapes, CDs, RAM devices, and other magnetic and optical media. The algorithms may also be implemented in a software executable object. Alternatively, the algorithms may be embodied in whole or in part using suitable hardware components, such as Application Specific Integrated Circuits (ASICs), state machines, controllers or other hardware components or devices, or a combination of hardware, software and firmware components.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method to facilitate an electronic payment transaction comprising:
receiving a request to initiate a communication session between a merchant terminal and a wireless data connection enabled computing device;
sending identifying information for the communication session to at least one of the merchant terminal and the wireless data connection enabled computing device;
receiving a payment transaction request from the merchant terminal during the communication session;
sending the payment transaction request to the wireless data connection enabled computing device during the communication session;
receiving a purchase authorization for the payment transaction request from the wireless data connection enabled computing device;
sending the payment transaction to a payment processor;
receiving an approval of the payment transaction from the payment processor; and
sending notification of the approval of the payment transaction to at least one of the merchant terminal and the wireless data connection enabled computing device to conclude the payment transaction.

2. The method of claim 1 further comprising receiving and storing purchase authorization information to document consent to the processing of the payment transaction.

3. The method of claim 2 further comprising receiving and storing identification information of an authorizing party related to the purchase authorization information to document evidence of the identity of the authorizing party.

4. The method of claim 1 wherein the communication session is a full duplex communication session.

5. The method of claim 1 wherein the communication session is an asynchronous communication session.

6. A system to facilitate an electronic payment transaction comprising:
at least one processing device configured to
receive a request to initiate a communication session between a merchant terminal and a wireless data connection enabled computing device,
send identifying information for the communication session to at least one of the merchant terminal and the wireless data connection enabled computing device,
receive a payment transaction request from the merchant terminal during the communication session,
send the payment transaction request to the wireless data connection enabled computing device during the communication session,
receive a purchase authorization for the payment transaction request from the wireless data connection enabled computing device,
send the payment transaction to a payment processor,
receive an approval of the payment transaction from the payment processor, and
send notification of the approval of the payment transaction to at least one of the merchant terminal and the wireless data connection enabled computing device to conclude the payment transaction.

7. The system of claim 6 wherein the at least one processing device is further configured to receive and store purchase authorization information to document consent to the processing of the payment transaction.

8. The system of claim 7 wherein the at least one processing device is further configured to receive and store identification information of an authorizing party related to the purchase authorization information to document evidence of the identity of the authorizing party.

9. The system of claim 6 wherein the communication session is a full duplex communication session.

10. The system of claim 6 wherein the communication session is an asynchronous communication session.

11. A method to execute an electronic payment transaction comprising:
initiating or receiving notification of the initiating of a communication session with a merchant terminal;
receiving a payment transaction request during the communication session from the merchant terminal;
sending an authorization for the payment transaction request; and
receiving an approval of the payment transaction to conclude the payment transaction.

12. The method of claim 11 further comprising sending purchase authorization information related to the payment transaction to indicate consent to processing of the payment transaction.

13. The method of claim 12 further comprising sending identification information of an authorizing party related to the purchase authorization information to evidence the identity of the authorizing party.

14. The method of claim 11 further comprising sending a selected payment instrument identifier to indicate a desired payment method.

15. The method of claim 11 further comprising receiving or sending event information during the communication session.

16. The method of claim 11 wherein the communication session is a full duplex communication session.

17. The method of claim 11 wherein the communication session is an asynchronous communication session.

18. The method of claim 11 further comprising receiving invoice information related to the payment transaction during the communication session for display.

19. A system for executing an electronic payment transaction comprising:
a wireless data connection enabled computing device configured to (i) initiate or receive notification of the initiating of a communication session with a merchant terminal, (ii) receive a payment transaction request during the communication session, (iii) send an authorization for the payment transaction request and (iv) receive an approval of the payment transaction to conclude the payment transaction.

20. The system of claim 19 wherein the wireless data connection enabled computing device is further configured to send purchase authorization information to indicate consent to processing of the payment transaction.

21. The system of claim 20 wherein the wireless data connection enabled computing device is further configured to send identification information of an authorizing party related to the purchase authorization information to evidence the identity of the authorizing party.

22. The system of claim 19 wherein the wireless data connection enabled computing device is further configured to receive invoice information related to the payment transaction during the communication session for display by the wireless data connection enabled computing device.

23. The system of claim 19 wherein the wireless data connection enabled computing device is further configured to send a selected payment instrument identifier to indicate a desired payment method.

24. The system of claim 19 wherein the wireless data connection enabled computing device is further configured to receive or send event information during the communication session.

25. The system of claim 19 wherein the communication session is a full duplex communication session.

26. The system of claim 19 wherein the communication session is an asynchronous communication session.

27. A method for executing an electronic payment transaction comprising:
initiating or receiving notification of the initiating of a communication session with a wireless data connection enabled computing device;
sending a payment transaction request during the communication session for the wireless data connection enabled computing device; and
receiving a payment confirmation or a rejection of the payment transaction request to conclude the payment transaction.

28. The method of claim 27 further comprising sending event information for the wireless data connection enabled computing device during the communication session.

29. The method of claim 28 wherein the event information is sent in response to the initiation of the communication session.

30. The method of claim 27 wherein the communication session is a full duplex communication session.

31. The method of claim 27 wherein the communication session is an asynchronous communication session.

32. The method of claim 27 further comprising sending invoice information related to the payment transaction during the communication session to inform a user of the wireless data connection enabled computing device about the payment transaction.

33. A system for executing an electronic payment transaction comprising:
at least one merchant terminal configured to (i) initiate or receive notification of the initiating of a communication session with a wireless data connection enabled computing device, (ii) send a payment transaction request during the communication session for the wireless data connection enabled computing device, and (iii) receive a payment confirmation or a rejection of the payment transaction request to conclude the payment transaction.

34. The system of claim 33 wherein the at least one merchant terminal is further configured to send event information for the wireless data connection enabled computing device during the communication session.

35. The system of claim 33 wherein the at least one merchant terminal is further configured to send the event information in response to the initiation of the communication session.

36. The system of claim 33 wherein the communication session is a full duplex communication session.

37. The system of claim 33 wherein the communication session is an asynchronous communication session.

38. The system of claim 33 wherein the at least one merchant terminal is further configured to send invoice information related to the payment transaction during the communication session to inform a user of the wireless data connection enabled computing device about the payment transaction.
